(19) United States
(12) Patent Application Publication
(10) Pub. No.: US 2016/0167530 A1
(43) Pub. Date: Jun. 16, 2016

(54) CHARGING METHOD FOR AN ENERGY ACCUMULATOR OF A VEHICLE

(71) Applicant: Siemens Aktiengesellschaft, Munchen (DE)

(72) Inventors: Ulrich Bolik, Bottrop (DE); Andreas Laske, Berlin (DE); Liam Mulligan, Dublin (IE); Anton Schmitt, Vaterstetten (DE)

(73) Assignee: Siemens Aktiengesellschaft, Munchen (DE)

(21) Appl. No.: 14/966,929

(22) Filed: Dec. 11, 2015

(30) Foreign Application Priority Data
Dec. 12, 2014 (EP) 14197729.8

(51) Int. Cl. B60L 11/18

(52) U.S. Cl. CPC B60L 11/182; B60L 11/1824

(57) ABSTRACT

In a method of charging an energy accumulator of a vehicle in a charging station, the presence of a vehicle is ascertained in a defined region in vicinity of the charging station via a wireless communication between a vehicle-side communication device and a communication device of the charging station. The charging process of the energy accumulator in the charging station is cleared, when the wireless communication between a vehicle-side communication device and a communication device of the charging station is established and a parking brake of the vehicle is activated.

### CROSS-REFERENCES TO RELATED APPLICATIONS

This application claims the priority of European Patent Application, Serial No. 14197729.8, filed Dec. 12, 2014, pursuant to 35 U.S.C. 119(a)-(d), the disclosure of which is incorporated herein by reference in its entirety as if fully set forth herein.

### BACKGROUND OF THE INVENTION

The present invention relates to a charging method for an energy accumulator of a vehicle, and to a charging station, to a vehicle, and to a system that includes a vehicle and a charging station.

The following discussion of related art is provided to assist the reader in understanding the advantages of the invention, and is not to be construed as an admission that this related art is prior art to this invention.

As a result of the need to reduce CO₂, those responsible in an increasing number of cities are considering to use in public transportation vehicles, in particular buses, which either have purely electric propulsion or are equipped at least with hybrid drives. Since the energy density of batteries at present is not yet sufficient to store the necessary quantity of energy to dispatch the vehicles for daily circulation, there is a need to recharge the energy accumulators at fixed charging stations which are distributed in the field of activity. However, there are to date no charging stations that satisfy the need for such vehicles.

Existing charging stations for private vehicles are generally small in size to permit, for example, their installation in a garage. Furthermore, the small structural size provides the possibility of retrofitting corresponding stations in public or private parking lots to permit vehicles to be charged there. These locations for the charging stations are selected because of a significantly longer time period required to charge the vehicles compared to refueling with conventional fuels such as petrol, diesel or gas. In current charging stations, the contact between the station and the vehicle is realized via a cable and a plug system which ensures safe transmission of current.

The use of trams and trolley buses is further known in the art for electrically operated transportation. These vehicles generally do not have an onboard energy accumulator which permits relatively long distances to be covered without external supply of energy. The electrical energy is transmitted continuously during operation, from an overhead line via a current collector on the vehicle.

There are also various peripheral conditions for the charging process. For example, the charging process should be as short as possible. For this reason, a high charging power is necessary. The required charging power is often above 100 kW, in some cases even significantly above 100 kW. Furthermore, the vehicle driver should not be expected to handle cable-bound plug-type connections and the like, because the cables and plugs are relatively heavy and bulky due to the necessary high voltages, currents and power levels. Furthermore, passersby in the vicinity of the road vehicle must not be placed in danger and should as far as possible also not be impeded. A further aspect is that the overall weight of the road vehicle is a critical factor. Therefore, the charging process should be implemented such that fewest possible additional components are need for installation on the road vehicle.

It would therefore be desirable and advantageous to address prior art problems and to enable charging of an energy accumulator of a vehicle in a safe, simple and cost-effective manner.

### SUMMARY OF THE INVENTION

According to one aspect of the present invention, a method of charging an energy accumulator of a vehicle in a charging station includes ascertaining the presence of a vehicle in a defined region in vicinity of the charging station via a wireless communication between a vehicle-side communication device and a communication device of the charging station, and clearing a charging process of the energy accumulator in the charging station, when the wireless communication between a vehicle-side communication device and a communication device of the charging station is established and a parking brake of the vehicle is activated.

According to another aspect of the present invention, a charging station for charging an energy accumulator of a vehicle, comprising a communication device configured for wireless communication with the vehicle, with the communication device having an antenna which has a directional characteristic configured to establish the wireless communication only when the vehicle is located in a region of the charging station to enable a charging process.

According to yet another aspect of the present invention, a vehicle includes an energy accumulator, a parking brake, a vehicle-side communication device operably connected to the parking brake in such a way that a signal about a state of the parking brake is transmittable to a charging station via a wireless communication between the charging station and the vehicle-side communication device, and an antenna having a directional characteristic configured to establish the wireless communication only when the vehicle is located in a region of the charging station to enable a charging process.

According to still another aspect of the present invention, a system includes at least one vehicle including an energy accumulator, a parking brake, an antenna, and a vehicle-side communication device operably connected to the parking brake, and at least one charging station for charging the energy accumulator of the vehicle, said charging station comprising a communication device configured for a wireless communication with the vehicle, said communication device having an antenna, wherein the antenna of the charging station and the antenna of the vehicle are arranged in such a way that the wireless communication is established only when the antenna of the charging station and the antenna of the vehicle have a specific alignment with one another.

The invention is based on the realization that the charging process can be made particularly simple, when the state of stoppage of the vehicle is determined by using the state of the parking brake. In the event, the parking brake is applied, i.e. activated, it can reliably be assumed that the vehicle is at a standstill. The parking brake is, in contrast to the brake which is actuated by the brake pedal (service brake), a brake which keeps the vehicle at a standstill after being applied or activated, even without further action by the driver. The driver can, for example, leave the vehicle after the parking brake has been activated. The parking brake is often also referred to as an arresting brake, handbrake or stop brake. The position P of an automatic transmission is also considered to be a parking brake in this context. In order to transmit information about the application of a parking brake to the controller of a charging station, a wireless communication between the vehicle and charging station is used for this purpose. In this way, the charging process can be cleared by the controller of the charging station. Clearance is a precondition for being able to start the charging process of the energy accumulator in the vehicle. The term “charging process” is understood to be the feeding of electrical energy into the energy accumulators of the vehicle. “Clearance” means that the flow of power between the charging station and the vehicle can be carried out by the controller. In the absence of a clearance, flow of power is prevented. In the event of a flow of power already being present, it is to be ended when clearance is absent or lost.

The wireless communication between a vehicle-side communication device and a communication device of the charging station can be configured in such a way that the wireless communication is established only when the vehicle is located in the vicinity of the charging station. The ranges of a radio link are to be correspondingly configured for this. Experience has shown that the driver of a vehicle can precisely position the vehicle at a charging station even without further measures or resources in such a way that charging of the vehicle at the charging station can be carried out. In particular, in the case of buses it has become apparent that the driver of the bus approaches a bus stop in such a way that the bus is positioned at the bus stop in a way which permits charging by means of the charging station to be carried out. Furthermore, it has become apparent that precise positioning of the bus by the driver can be carried out particularly easily when a separate bay is provided for the bus at the bus stop where there is also a charging station.

It has proven particularly advantageous in the event of the vehicle being a bus to locate at least one charging station at the terminus. The charging process can therefore easily be carried out, while the driver takes a break. Furthermore, in comparison to a stop at another bus stop, a relatively long time is available at the terminus for the charging process. Charging times become possible with the method according to the invention in the order of magnitude of six minutes.

An advantage of the present invention is the possibility to eliminate the need for sensors to detect the standstill of the vehicle. The method according to the invention and the charging station according to the invention can therefore be implemented easily and cost-effectively. Sensors for detecting the state of the arresting brake are customary for visual display nowadays, with the result that no further costs for the determination of the state are incurred here. Furthermore, the detection of the state of the parking brake is much less susceptible to failure, in contrast to sensors which ascertain the standstill of a vehicle.

Advantageously, the wireless communication is used to determine whether the vehicle is located in a defined region in the vicinity of the charging station. The wireless communication can be used to determine the position of the vehicle in the vicinity of the charging station. In addition to the dimensions of the range of the communication devices, antennas which have a directional characteristic can be used for this purpose both at the charging station and in the vehicle. With this directional characteristic, the wireless communication takes place only when the antennas have a specific alignment with one another. This is the case when the vehicle is located in a region at the charging station in which charging is possible. Furthermore, it has proven advantageous to arrange more than one antenna in the vehicle and/or at the charging station. As a result of the corresponding directional characteristics of the individual antennas, the position of the vehicle can be determined even more precisely. On the basis of this information, it is possible to determine whether the vehicle is located in a region of a charging station in which charging is possible. Furthermore, the use of more than one antenna for wireless communication permits the transmission of information to be made redundant. It is therefore possible to maintain a wireless communication between a vehicle and a charging station even in the event of a failure of an antenna. For the determination of the position of the vehicle by means of the wireless communication, there is no longer any need for sensors, in particular distance sensors, in order to determine the position of the vehicle at the charging station with sufficient precision. Since these sensors have a failure probability which is not negligible, the use of the wireless communication for the determination of position makes it possible both to construct the charging station cost-effectively and to operate it reliably.

According to another advantageous feature of the present invention, the vehicle can be connected to an electrical reference potential via an electrical connection between the charging station and the vehicle to safeguard against injury by a person touching the vehicle during the charging process. The reference potential may hereby be a ground potential. For safe charging of the energy accumulator, it must be ensured that no injury can occur to persons if a person touches the vehicle during the charging process. This is significant, in particular, when the voltage which is used for charging the energy accumulator is so high that it can cause injury to persons. At the same time, high voltage is necessary to implement short charging times, In order to be able to implement the high voltage for the charging, it must be ensured that the vehicle has an electrical potential which corresponds to the ground potential or at least does not differ from the ground potential to such an extent that unintended currents which are hazardous to persons can occur. For this purpose, the body of the vehicle is connected to a reference potential. In particular, the ground potential is suitable as a reference potential. In order to implement this, the charging station has a first contact whose electrical potential corresponds to the reference potential. This is electrically connected to the vehicle during the charging process. Within the vehicle, it is ensured that the vehicle body is connected to this electrical reference potential. The vehicle body includes most of the metallic outer skin of the vehicle, also referred to as the bodywork, as well as parts, in particular electrically conductive parts, of the interior of the vehicle. The possibility of persons in the surroundings of the vehicle being put in danger just by touching the vehicle can therefore be ruled out. Therefore, sufficient safety with respect to the protection of persons can be achieved, in particular, for buses in which persons get in and out.

According to another advantageous feature of the present invention, a connection of the vehicle to the reference potential can be ensured by detecting a contact between the charging station and the vehicle in the presence of a flow of current between the charging station and the vehicle. In order to ensure protection against direct contact, it is important that the vehicle body is connected to a reference potential. This is ensured by the contact between a first contact of the charging station and the vehicle. In order to make the method particularly safe, it is checked with a second contact whether the contact between the charging station and the vehicle is safely established by the first contact. For this purpose, a current, a so-called test current, is generated by means of the second contact of the charging station. In the presence of a flow of test current between the charging station and the vehicle, it can reliably be assumed that the contact has been established. For a reverse current, the first contact can be used for applying the reference voltage to the vehicle. As a result of the low level of the test current, there is no appreciable change in voltage, caused by the test current, between the potential of the vehicle and the reference potential to be expected. In order to detect the safe connection by means of the test current, a voltage measurement can also be used in addition to the current measurement. It has proven advantageous hereby to introduce a defined resistance into the circuit and to measure the voltage drop caused by the test current at this resistance.

The current can hereby additionally be influenced by the vehicle in such a way that a communication is established between the vehicle and the charging station. This simple communication can be used, for example, to end a charging process quickly in the event of a fault or of danger. For this purpose, a switch can be introduced into the current path on the vehicle side, which switch interrupts the test current for monitoring the safe contact. It is therefore possible on the vehicle side to interrupt the charging process even if the wireless communication is disrupted.

According to another advantageous feature of the present invention, the charging process can automatically start, when the charging process is cleared. In order to free the driver of a vehicle largely from a need to perform actions to charge the energy accumulator of the vehicle, the charging process is started automatically when the charging process is cleared. Therefore, the charging process can be started automatically when a charging station is reached and a wireless communication is established between the vehicle and the charging station by applying the parking brake. It has proven advantageous particularly for application in buses with charging at bus stops, when the charging process can be started automatically. The driver can then dedicate himself to other tasks such as, for example, the sale of tickets, without having to initiate or monitor the charging process. Furthermore, it has proven advantageous to perform the charging of the energy accumulator of buses at its terminuses. The driver can also be relieved here by the automatic sequencing of the charging process, with the result that he can use this charging time as rest time.

According to another advantageous feature of the present invention, the charging process can be terminated, when the parking brake of the vehicle is deactivated. In order to reliably rule out a vehicle moving away from the charging station during the charging process, it has proven advantageous to end the charging process as soon as the parking brake of the vehicle is deactivated, i.e. released. As a result of the deactivation of the brake, it can be assumed that the vehicle can intentionally or unintentionally be set in motion. In order to prevent the voltage-conducting contacts which are necessary for the charging from coming into contact with the vehicle body, the charging process is interrupted with the deactivation of the parking brake. This has the advantage that the driver does not have to initiate the end of the charging process himself. Furthermore, a forgetting of a termination of the charging process and associated damage to the system or injuries to persons can be reliably ruled out. In particular, when the vehicle is a bus, the driver can be relieved of the task of monitoring the charging process.

According to another advantageous feature of the present invention, the charging station can have third and fourth contacts configured for connection to the vehicle during the charging process so as to enable transmission of electrical energy from the charging station to the energy accumulator of the vehicle via the third and fourth contacts. It has proven appropriate that, if a first and a second contact are already present at the charging station, a third contact and a fourth contact, with which the charging of the energy accumulator takes place, are provided in order to protect the vehicle body reliably against unacceptable touch voltages. These contacts are configured to transmit to the vehicle a high voltage and correspondingly high currents with which a short charging time of the energy accumulator is achieved. In this context, voltage values of approximately 450 V to 750 V DC between the third and fourth contacts have proven particularly beneficial. Likewise, currents of 200 A, 400 A and 600 A have proven beneficial for charging the energy accumulator. Safe and fast charging can therefore be implemented in a simple manner by using four contacts at the charging station and corresponding receiving contacts on the vehicle.

According to another advantageous feature of the present invention, the charging station can have at least one attachment rail, with at least one of the first, second, third and fourth contacts being arranged on the attachment rail. Contact can be made with a charging station in a particularly easy way using the attachment rail. The contact is then advantageously embodied in a strip shape. It has proven particularly advantageous to arrange a plurality of contacts on an attachment rail, wherein the contacts are electrically insulated from one another. The attachment rail can easily be electrically insulated in a safe and reliable way from the charging station by means of insulators. By using attachment rails, it is easily possible to place the charging station in contact with the vehicle. For this purpose, a device which places the contacts of the charging station in contact with the receiving contacts of the vehicle by means of a movement is to be implemented on the charging station side or vehicle side.

According to another advantageous feature of the present invention, the charging station can have two attachment rails arranged in parallel relationship, wherein two of the first, second, third and fourth contacts are arranged electrically insulated from one another on one of the attachment rails and two further ones of the first, second, third and fourth contacts are arranged electrically insulated from one another on the other one of the attachment rails. With this arrangement it is possible to accommodate at least four contacts in a relatively small space. The contacts which are then arranged in a strip shape on the attachment rail can be particularly easily connected to the vehicle. By mounting the contacts on attachment rails, a high level of tolerance can be achieved with respect to the positioning of the vehicle on the charging station. At the same time, the use of material during the manufacture of contacts and attachment rails is relatively low. Therefore, by using two parallel attachment rails, it is possible to realize a charging station in a cost-effective and low-weight fashion, which charging station at the same time makes only small requirements of the accuracy of the positioning of the vehicle at the charging station.

According to another advantageous feature of the present invention, the charging station can have a current collector configured to connect at least one of the first, second, third and fourth contacts to the vehicle. In order to largely minimize the weight of the vehicle, it has proven appropriate to arrange the current collector, as a device which connects the contacts of the charging stations and the receiving contacts of the vehicle, on the charging station. Therefore, on the one hand additional weight on the vehicle is avoided and tightly dimensioned installation space in the vehicle is not taken up by additional components such as a current collector. This has a particularly favorable effect on the manufacture of the vehicles.

According to another advantageous feature of the present invention, the current collector can be configured to lower the at least one of the first, second, third and fourth contacts to be able to make contact with the vehicle, and to place in a position of rest the at least one of the first, second, third and fourth contacts at a level that prevents connection to the vehicle. This has the advantage that when operation is lost, for example as a result of a power failure, the current collector does not rest on the vehicle and make a connection to the vehicle just as a result of the weight of the current collector. In such a case, it would not be possible for the vehicle to leave the charging station. In order to be able to move the vehicle away from the charging station even in the event of a power failure or other fault situation of the charging station, without causing damage to the current collector, it is furthermore advantageous when, in the event of failure of operation, the current collector in its position of rest, i.e. without actuation from the outside, is moved into a position and/or held in a position in which the current collector is no longer in contact with the vehicle, for example by using a spring or a counterweight. In this case, the vehicle can leave the charging station without risk.

According to another advantageous feature of the present invention, the charging station can include at least one attachment rail and at least one contact on the at least one attachment rail, and the bus can include at least one rail for making contact with the at least one contact on the at least one attachment rail of the charging station, said rail of the bus being arranged substantially at a right angle to the attachment rail of the charging station, when the rail of the bus contacts the at least one contact on the attachment rail. As a result of the arrangement of the contacts of the charging station on attachment rails and the use of rails on the vehicle for making contact, the corresponding contact faces are configured in a strip shape both on the vehicle side and on the charging station side. When these strip-shaped contact-making faces are arranged at a right angle to one another during the contact-making process, a relatively large tolerance range for the positioning of the vehicle occurs for the contact-making faces given relatively low use of material by virtue of the fact that an electrical connection can be established safely between the charging station and the vehicle. The low use of material brings about a cost-effective implementation of the contacts both on the vehicle side and on the charging station side. Furthermore, the rails increase the weight of the vehicle only insignificantly. The rails can also be integrated easily into the appearance of the vehicle by simple vehicle design measures.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a system with a vehicle and charging station in accordance with the present invention;

FIG. 2 is a schematic illustration of a vehicle at the charging station; and

FIG. 3 is a perspective illustration of a current collector in a state of formation of contact with the vehicle.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

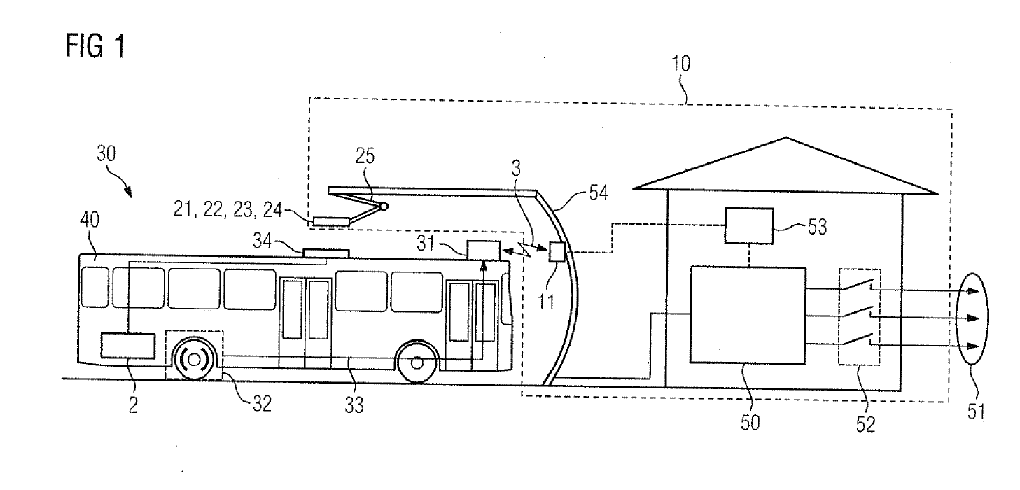

Turning now to the drawing, and in particular to FIG. 1, there is shown a schematic illustration of a system with a vehicle 30 in the form of a bus with an energy accumulator 2 and a charging station 10. The charging station 10 has a mast 54 to which a current collector 25 is attached. The contacts 21, 22, 23, 24 of the charging station 10 can be placed in contact with a rail 34 of the vehicle with the current collector 25. A communication device 11 of the charging station 10 is mounted on the mast 54 of the charging station 10. A wireless communication 3 with a vehicle-side communication device 31 of the vehicle 30 can be established with this communication device 11 of the charging station 10. The charging station 10 also comprises a power converter 50 which is connected to an energy supply system 51 via a switch 52. In order to charge the energy accumulator 2, the power converter 50 converts the power supply voltage with the energy supply system 51 in such a way that a voltage of permits the energy supply system 51 to charge the energy accumulator 2 of the vehicle 30 is present at the third and fourth contacts 23, 24 of the charging station 10. The third contact 23 and the fourth contact 24 are connected here to the power converter 50. The voltage which is present at these contacts is regulated by means of a regulator 53 of the charging station 10. Values which are transmitted from the vehicle 30 to the regulator 53 of the charging station by means of the wireless communication 3 serve as input variables for the regulator 53. Inter alia it is possible to detect on this basis to what extent the accumulator 2 of the vehicle 30 is already charged. The switch 52 permits the power converter 50 of the charging device and therefore also the third and fourth contacts 23, 24 to be disconnected from the energy supply system. It has proven particularly favorable to use a three-phase low voltage power system of 400 V or a three-phase medium voltage power system of 10 kV, 50 Hz or 60 Hz for the energy supply system. The vehicle 30 has, in addition to the energy accumulator 2, a rail 34 for making contact with the charging station 10. The rail 34 for making contact is connected to the energy accumulator 2. A further connection of the rail 34 is connected to the vehicle structure 40. This connection is not illustrated in FIG. 1 for the sake of clarity. It is envisioned for the first contact 21 of the charging station 10 to be connected in an electrically conductive fashion to the vehicle body 40 in such a way that the vehicle body 40 receives the electrical potential of the first contact 21. In this way, as described at the beginning, the contact protection of the vehicle 30 is ensured and injury to persons by an electric shock is reliably avoided. Furthermore, the vehicle 30 has a vehicle-side communication device 31. This serves to establish a wireless communication 3 with the charging station 10. The vehicle 30 also has a parking brake 32. This is illustrated in FIG. 1 as a brake for the rear axle. However, it can alternatively or additionally also act on the front axle. It is also possible for the parking brake to act on just one wheel or on individual wheels of the vehicle 30. A signal 33 relating to the state of the parking brake 32 is transmitted from the parking brake 32 to the vehicle-side communication device 31. The information relating to the state of the parking brake 32 also passes via the wireless communication 3 to the regulator 53 of the charging station 10. On the basis of the presence of the wireless communication 3 and the state of the parking brake 32, the regulator 53 of the charging station can determine whether it is possible to start the charging process.

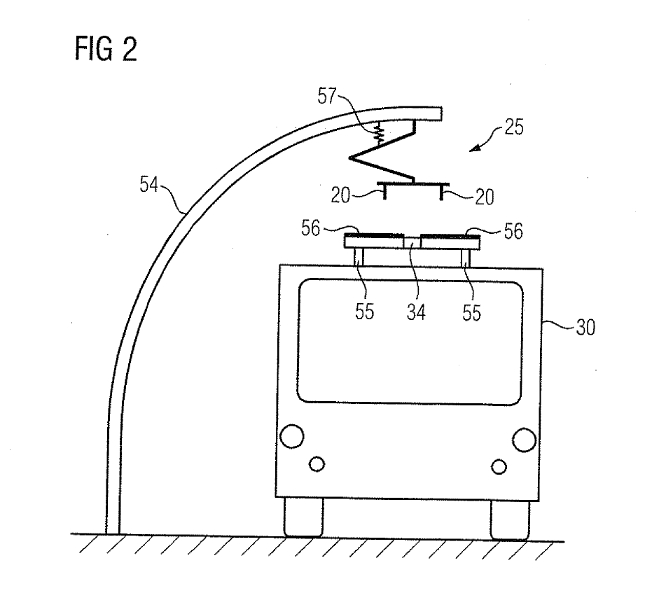

FIG. 2 shows a vehicle at a charging station 10. A current collector 25 is attached to the mast 54 of the charging station 10 and establishes an electrical connection with the vehicle 30 by lowering attachment rails 20. In order to avoid repetition, reference is made to the description relating to FIG. 1 and to the reference symbols introduced there. In this exemplary embodiment, the contacts 21, 22, 23, 24 are not illustrated for sake of clarity. In this exemplary embodiment, the contacts 21, 22, 23, 24 are also arranged respectively insulated from one another on the attachment rail 20. The rail 34 of the vehicle 30 for making contact is attached to the roof of the vehicle 30 via insulators 55. The receiving contacts 56 of the vehicle 30 are arranged on the rail 34. The individual receiving contacts 56 of the vehicle 30 are each electrically insulated from one another. By lowering the current collector 25, the individual contacts 21, 22, 23, 24 of the charging station are connected to corresponding receiving contacts of the vehicle 30. The current collector 25 has a spring 57 in this exemplary embodiment. The spring 57 ensures that the current collector 25 is located in a raised position when it is not actuated. Therefore, for example in the event of a power failure or a fault in the actuation, the current collector 25 is prevented from maintaining a contact with the vehicle due to the weight of the current collector 25. In the event of a fault such as, for example, interruption of the power supply, the vehicle 30 can therefore leave the charging station 10 without components of the charging station 10 or of the vehicle 30 being damaged.

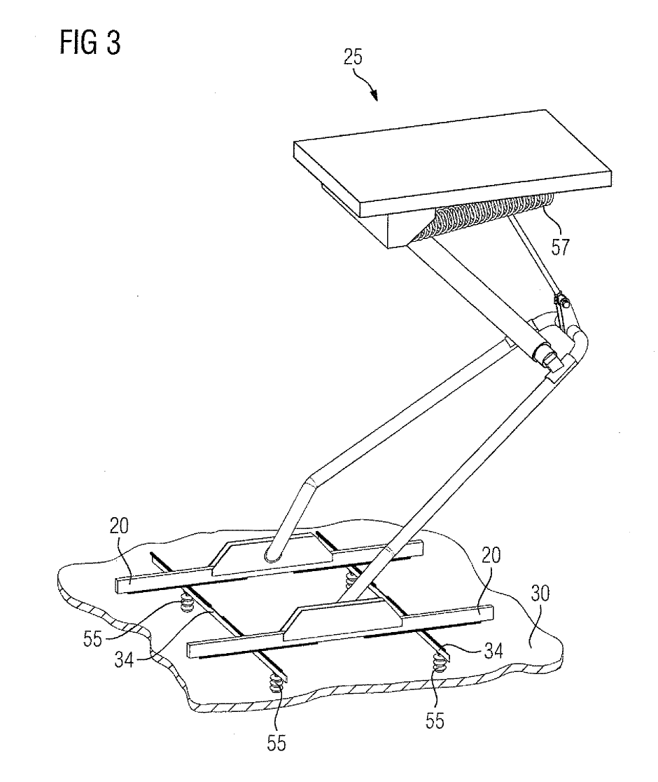

FIG. 3 shows a current collector 25 in a lowered position, with the result that the attachment rails 20 are in contact with the rail 34 of the vehicle. In order to avoid repetitions, reference is made to the description relating to FIGS. 1 and 2 and to the reference symbols introduced there. The individual contacts 21, 22, 23, 24 which are arranged on the attachment rail 20 and the receiving contacts 56 of the vehicle 30 are not illustrated for the sake of clarity. The rail 34 for making contact is attached to the roof of the vehicle 30 by means of insulators 55. It has proven particularly advantageous for the attachment rails 20 of the charging station 10 and the rails 34 for making contact with the vehicle 30 to be arranged essentially at a right angle to one another when contact is made. In other words, the attachment rails 20 of the charging station and the rails 34 for making contact form a rectangle, or a square when the distance of the respective rails from one another is the same. Therefore, a high level of tolerance with respect to the positioning of the vehicle 30 at the charging station 10 can be achieved with relatively little use of material. The spring 57 of the current collector 25 has the effect that when actuation is not occurring, i.e. in the quiescent state of the current collector 25, the current collector 25 moves into a raised position or remains there. In this position, the attachment rails 20 are disconnected from the rails 34 of the vehicle 30, with the result that the vehicle 30 can leave the charging station 10, without causing damage to the charging station or the vehicle.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of charging an energy accumulator of a vehicle in a charging station, comprising:
ascertaining the presence of a vehicle in a defined region in vicinity of the charging station via a wireless communication between a vehicle-side communication device and a communication device of the charging station; and
clearing a charging process of the energy accumulator in the charging station, when the wireless communication between a vehicle-side communication device and a communication device of the charging station is established and a parking brake of the vehicle is activated.

2. The method of claim 1, further comprising connecting the vehicle to an electrical reference potential via an electrical connection between the charging station and the vehicle to safeguard against injury by a person touching the vehicle during the charging process.

3. The method of claim 2, wherein the reference potential is a ground potential.

4. The method of claim 2, further comprising ensuring a connection of the vehicle to the reference potential by detecting a contact between the charging station and the vehicle in the presence of a flow of current between the charging station and the vehicle.

5. The method of claim 1, further comprising automatically starting the charging process when the charging process is cleared.

6. The method of claim 1, further comprising terminating the charging process when the parking brake of the vehicle is deactivated.

7. A charging station for charging an energy accumulator of a vehicle, comprising a communication device configured for wireless communication with the vehicle, said communication device having an antenna which has a directional characteristic configured to establish the wireless communication only when the vehicle is located in a region of the charging station to enable a charging process.

8. The charging station of claim 7, further comprising a first contact configured for connection to a body of the vehicle during the charging process so as to electrically connect the vehicle body to a defined reference potential.

9. The charging station of claim 8, further comprising a second contact configured for connection to the vehicle during the charging process so as to ensure a connection of the vehicle to the reference potential by detecting a contact between the charging station and the vehicle in the presence of a flow of current between the second contact of the charging station and the vehicle.

10. The charging station of claim 9, further comprising third and fourth contacts configured for connection to the vehicle during the charging process so as to enable transmission of electrical energy from the charging station to the energy accumulator of the vehicle via the third and fourth contacts.

11. The charging station of claim 10, further comprising at least one attachment rail, at least one of the first, second, third and fourth contacts being arranged on the attachment rail.

12. The charging station of claim 10, further comprising two attachment rails arranged in parallel relationship, wherein two of the first, second, third and fourth contacts are arranged electrically insulated from one another on one of the attachment rails and two further ones of the first, second, third and fourth contacts are arranged electrically insulated from one another on the other one of the attachment rails.

13. The charging station of claim 10, further comprising a current collector configured to connect at least one of the first, second, third and fourth contacts to the vehicle.

14. The charging station of claim 13, wherein the current collector is configured to lower the at least one of the first, second, third and fourth contacts to be able to make contact with the vehicle, and to place in a position of rest the at least one of the first, second, third and fourth contacts at a level that prevents connection to the vehicle.

15. A vehicle, comprising:
an energy accumulator;
a parking brake;
a vehicle-side communication device operably connected to the parking brake in such a way that a signal about a state of the parking brake is transmittable to a charging station via a wireless communication between the charging station and the vehicle-side communication device; and
an antenna having a directional characteristic configured to establish the wireless communication only when the vehicle is located in a region of the charging station to enable a charging process.

16. A system, comprising:
at least one vehicle including an energy accumulator, a parking brake, an antenna, and a vehicle-side communication device operably connected to the parking brake; and
at least one charging station for charging the energy accumulator of the vehicle, said charging station comprising a communication device configured for a wireless communication with the vehicle, said communication device having an antenna,
wherein the antenna of the charging station and the antenna of the vehicle are arranged in such a way that the wireless communication is established only when the antenna of the charging station and the antenna of the vehicle have a specific alignment with one another.

17. The system of claim 16, wherein the vehicle is a bus, and wherein the charging station is arranged at a terminus.

18. The system of claim 17, wherein the charging station includes at least one attachment rail and at least one contact on the at least one attachment rail, said bus including at least one rail for making contact with the at least one contact on the at least one attachment rail of the charging station, said rail of the bus being arranged substantially at a right angle to the attachment rail of the charging station, when the rail of the bus contacts the at least one contact on the attachment rail.
